(19) United States
(12) Patent Application Publication
(10) Pub. No.: US 2018/0121174 A1
(43) Pub. Date: May 3, 2018

(54) CENTRALIZED CODING TIME TRACKING AND MANAGEMENT

(71) Applicant: Microsoft Technology Licensing, LLC., Redmond, WA (US)

(72) Inventors: Ryan Patrick Phillips, Bellevue, WA (US); Brittany Ann Chua, Bellevue, WA (US); Alexander Whitmore Halfpenny, Seattle, WA (US)

(73) Assignee: Microsoft Technology Licensing, LLC., Redmond, WA (US)

(21) Appl. No.: 15/336,740

(22) Filed: Oct. 27, 2016

(51) Int. Cl. G06F 9/44; G06Q 10/10

(52) U.S. Cl. CPC G06F 8/36; G06Q 10/1091

(57) ABSTRACT

Centralized tracking and management of coding time in a distributed source control system environment for determining software development agility is provided. A centralized coding time tracking and management (CCTTM) tool is provided that gathers file edit data from developers' machines, collects file commit data associated with changes pushed to a centralized server, aggregates the collected data into a merged table, analyzes the aggregated data, and generates reports that indicate a level of agility of a company's I2D pipeline.

### BACKGROUND

Idea-to-data or I2D is an engineering velocity metric for measuring a development release pipeline or the amount of time from which an idea is born (e.g., when an idea for a feature or bug is initially thought of) to the time that telemetry data is first received. I2D includes an inner loop measurement and an outer loop measurement. The inner loop measurement is a measurement of the coding time, and includes the time from when a developer checks out a file or a set of files to the time when those files are committed back to the main codebase.

Tracking the inner loop measure of I2D is a straight-forward and well-understood measurement when using a centralized source control system; however, in some situations, a software development company may utilize distributed source control system or a hybrid approach, where some developers may use a distributed source control system, but may also need to check their source code into their company's centralized source control system for verification and building. For example, a software development company may decide to transition from using one type of source control system to another (e.g., transition from using a centralized source control system to a distributed source control system, transition from using a distributed source control system to a centralized source control system, transition from using one centralized source control system to another centralized source control system, or transition from using one distributed source control system to another distributed source control system). As can be appreciated, the company may have a large investment in their current source control system for building, testing, and deploying, and may find it difficult to migrate all existing tools that rely on the current source control system to a new source control system at once or within a short time frame. However, the company may still wish to continue to develop software while transitioning from one system to another.

There is a need to be able to manage and track source code file edit time (inner loop measurement of I2D) in a distributed source control system environment. Being able to track the inner loop measurement of I2D enables a software development company to measure productivity and performance for determining effectiveness of a particular source control system and for increasing efficiency in developing and releasing software.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

Aspects are directed to an automated system, method, and computer storage device for providing centralized tracking and management of coding time in a distributed source control system environment for determining software development agility. Development agility can provide a competitive advantage for a software development company. For example, the shorter a company's I2D time, the more agile the company is. A centralized coding time tracking and management (CCTTM) tool is provided that retrieves file edit data from developers' machines, collects file commit data associated with changes pushed to a centralized server, aggregates the collected data, analyzes the aggregated data, and generates reports that indicate a level of agility of a company's I2D pipeline. The CCTTM tool improves the efficiency of computing systems in a distributed environment by managing and tracking the progress of source code edits by a centralized administrator. Aspects enable the company to better measure and predict the efficiency of components in their engineering system and in their release pipeline. Further, business decisions can be made based on the gathered and aggregated data.

Examples are implemented as a computer process, a computing system, or as an article of manufacture such as a device, computer program product, or computer readable media. According to an aspect, the computer program product is a computer storage media readable by a computer system and encoding a computer program of instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a block diagram of an example operating environment including a centralized coding time tracking and management tool for providing centralized tracking and management of coding time in a distributed source control system environment;

FIG. 2 is a block diagram showing components of the a centralized coding time tracking and management tool;

FIG. 3 is an illustration showing an example of an aggregation of data collected via an edit service and a commit service;

FIG. 4 is a flow chart showing general stages involved in an example method for providing centralized tracking and management of coding time in a distributed source control system environment;

FIG. 5 is a block diagram illustrating example physical components of a computing device;

FIGS. 6A and 6B are block diagrams of a mobile computing device; and

FIG. 7 is a block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Aspects of the present disclosure are directed to a method, system, and computer storage media for providing centralized tracking and management of coding time in a distributed source control system environment. As described above, in some examples, a software development company may utilize a hybrid approach where some developers may use a distributed source control system for making code changes, and a centralized server for checking in their source code changes for verification and build.

For example, a distributed source control system provides revision control on a peer-to-peer model, where each peer's working copy of the source code is a complete source code repository. A distributed source control system may or may not include a central repository on which client computing devices synchronize a centralized main codebase. A centralized source control system permits revision control from a centralized location, typically based on a client/server model. For example, in a centralized source control system, a source code repository may be maintained on one or more servers. A software developer on a client computing device may check out source code from the source code repository, and check in source code to the source code repository after changes are made. In a hybrid source control system environment, a developer may check out source code from a centralized source control system repository, merge the source code into a working copy of source code in a local repository associated with a distributed source control system, and after changes are made, check in the source code to the centralized source control system repository for verification and build.

A centralized coding time tracking and management (CCTTM) tool acts as a centralized administrator that provides centralized tracking and management of coding time in a distributed source control system environment by gathering file edit data from developers' machines, collecting file commit data associated with changes pushed to a centralized server, synchronizes and aggregates the collected data, analyzing the aggregated data, and generating reports that indicate a level of agility of a company's I2D pipeline.

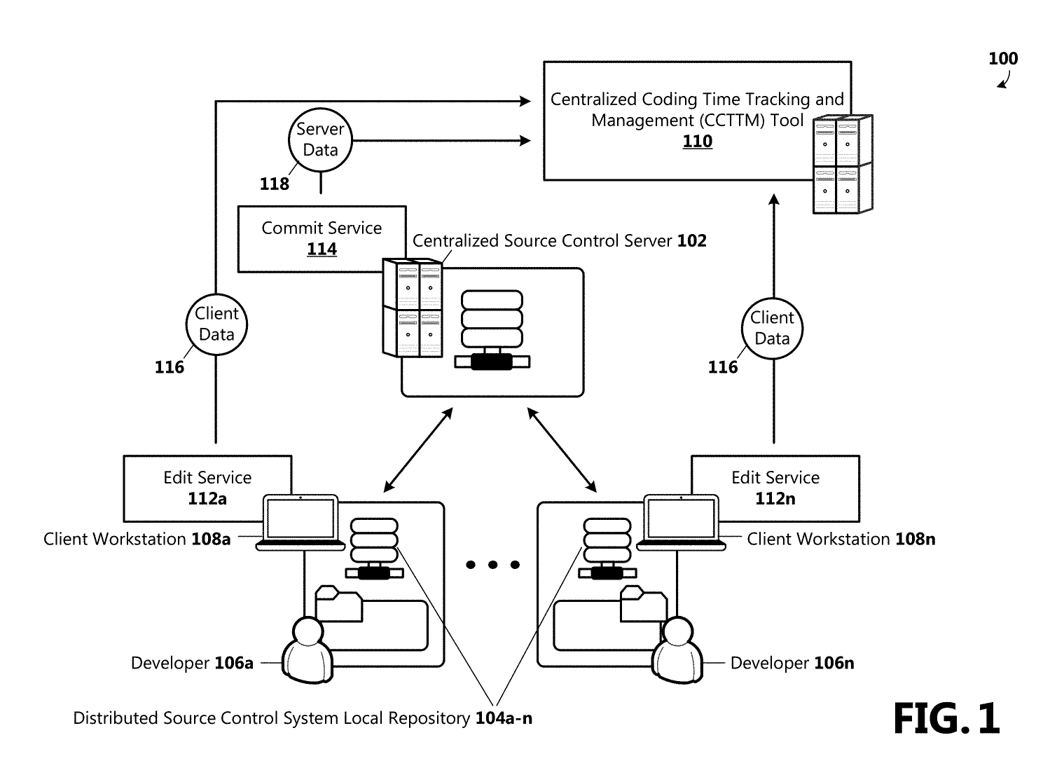

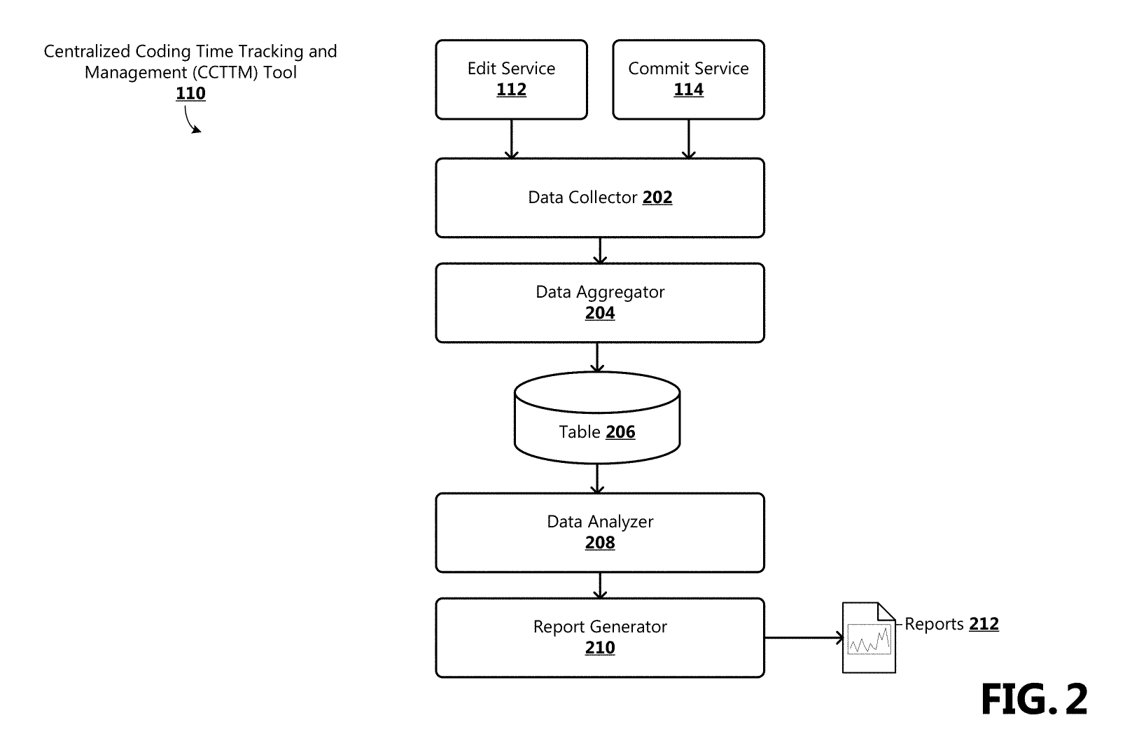

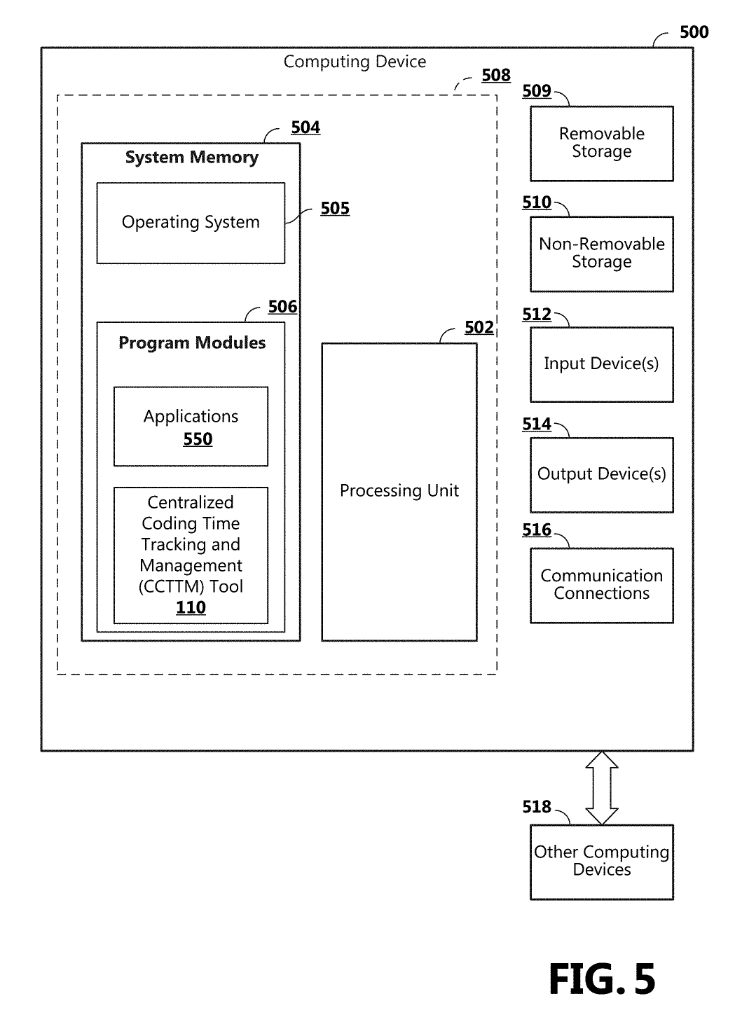

With reference now to FIG. 1, an example operating environment 100 including a CCTTM tool 110 for providing centralized tracking and management of coding time in a distributed source control system environment is shown. According to aspects, the CCTTM tool 110 is illustrative of software module, system, or device operative to retrieve client data 116 from one or more distributed source control system repositories 104 associated with edits made to source code files. Further, the CCTTM tool 110 is operative to retrieve commit and file data associated with pushes of source code edits to a centralized server 102. The CCTTM tool 110 is operative to aggregate and match pieces of the retrieved data, analyze the aggregated data, determine the inner loop of I2D for a file, and generate a reports associated with the inner loop metrics. Various components of the CCTTM tool 110 are described in further detail below with respect to FIG. 2. The various components may operate on a single computer or on a plurality of computing devices. The hardware of these computing devices is discussed in greater detail in regard to FIGS. 5, 6A, 6B, and 7.

The example operating environment 100 includes one or more client workstations 108a-n (collectively 108) or client computing devices via which users or software developers 106a-n (106) can use to write and edit source code used to build a particular software system, application, or software component. The client workstations 108 are operative to communicate over a network, which may include wired or wireless networking, with a centralized source control server 102 or other client workstations in a distributed source control system, for managing different versions of source code files that are compiled together to create executables that are shipped to customers.

According to an aspect, the example operating environment 100 includes at least one edit service 112a-n (collectively 112), illustrative of a software module, system, or device operative to collect telemetry or client data 116 associated with source code file edits in the distributed source control system. For example, the edit service 112 checks the status on each distributed control system local repository 104 to retrieve a list of files that are currently being edited, and captures file edit time information associated with files that have been updated since the edit service's last run. The client data 116 is communicated with the CCTTM tool 110.

According to an aspect, the edit service 112 runs continually on a selected or predetermined time interval (e.g., every 1 minute, every 5 minutes, every 30 minutes, once a day). The file edit information captured by the edit service 112 includes information such as: the name of the distributed control system local repository 104 from which the information is being captured, the developer's organization and team, the branch in the source code that was updated, an identifier associated with the machine (client workstation 108) used to update the file, the developer's user domain and user alias, the edit time, and the file path.

In some examples, the edit service 112 operates on each client workstation 108, and pushes the client data 116 to the CCTTM tool 110. In other examples, the edit service 112 is a component of the CCTTM tool 110, and operates on a server computer, for example, one or more server computers of the CCTTM tool 110, and pulls the client data 116 from the local distributed source control system repository 104 on the client workstation 108. In some examples, each client workstation 108 includes an edit service application programming interface (API) that allows communication of client data 116 between the local distributed source control system repository 104 and the CCTTM tool 110 via stored instructions.

In some examples, the edit service 112 is further operative to verify whether a local distributed source control system repository 104 still exists. If it does not, the edit service 112 is operative to remove the local distributed source control system repository 104 from a list of repositories, and to remove shortcuts to the repository.

According to an aspect, the example operating environment 100 includes a commit service 114, illustrative of a software module, system, or device operative to collect and send server data 118 associated with check-ins of source code files to the centralized source control server 102 where the files are committed back to the main codebase. For example, the commit service 114 is operative to query the centralized source control server 102 for all pushes and their related commits and files since a last run. For each commit in a push and for each file in a commit, the commit service 114 is operative to collect information, such as: the developer's organization and team, the repository from where the push was received, the file path, the change type (e.g., add, edit, remove), a name or alias of the developer 106, an identifier associated with the push, an email address used to push changes to the server, an identifier associated with the commit, a date of the commit, and a date of a parent commit. The server data 118 is communicated with the CCTTM tool 110.

According to an aspect, the commit service 114 runs continually on a selected or predetermined time interval (e.g., once a day, once every other day, once a week). In some examples, the commit service 114 operates on or in conjunction with the centralized source control server 102, and pushes the server data 118 to the CCTTM tool 110. In other examples, the commit service 114 is a component of the CCTTM tool 110, and operates on a server computer of the one or more server computers of the CCTTM tool 110, and pulls the server data 118 from a centralized repository of the centralized source control system 102. In some examples, centralized source control server 102 includes a commit service API that allows communication of server data 118 between the centralized source control system and the CCTTM tool 110 via stored instructions.

In some examples, the commit service 114 is further operative to analyze edit data from a previous run to determine whether there are any new local distributed source control system repositories 104 to monitor, and updates the directory of repositories to include new repositories.

With reference now to FIG. 2, various components of the CCTTM tool 110 are illustrated. The various components include a data collector 202, a data aggregator 204, a table 206, a data analyzer 208, and a report generator 210. According to an aspect, the data collector 202 is illustrative of a software module, system, or device operative to retrieve the client data 116 and server data 118 described above. For example, the data collector 202 is operative to retrieve the client data 116 and server data 118, and store the retrieved data in a database.

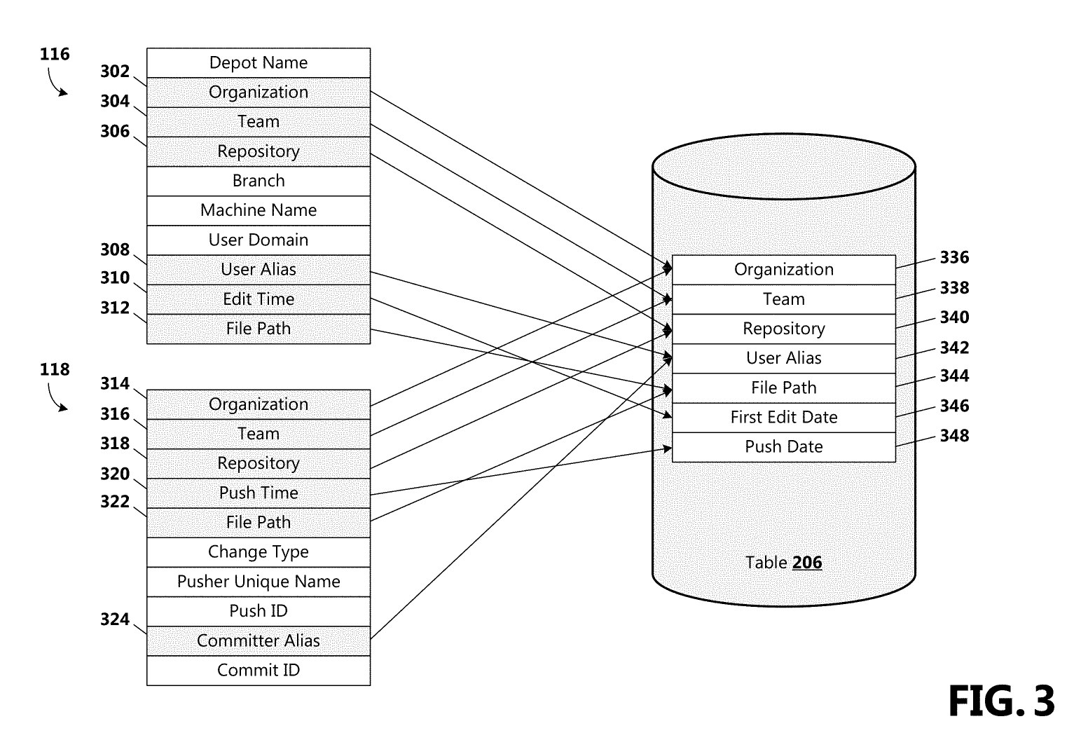

According to an aspect, the data aggregator 204 is illustrative of a software module, system, or device operative to match values of the client data 116 and the server data 118, and aggregate the values into a single merged table 206 that outlines the coding time (i.e., from a first edit to its push to the server) of a source code file. With reference to FIG. 3, an illustration of a synchronization of client data 116 and server data 118 into the merged table 206 is shown. For example, various pieces of the client data and various pieces of the server data are synchronized. In one example: the organization 302 value from the client data 116 and the organization 314 value from the server data 118 are matched and aggregated into an organization 336 field in the merged table 206; the team 304 value from the client data and the team 316 value from the server data are matched and aggregated into a team 338 field in the merged table; the repository 306 value from the client data and the repository 318 value from the server data are matched and aggregated into a repository 340 field in the merged table; the user alias 308 value from the client data and the committer alias 324 value from the server data are matched and aggregated into a user alias 342 field in the merged table; the file path 312 value from the client data and the file path 322 value from the server data are matched and aggregated into a file path 344 field in the merged table; the edit time 310 value from the client data is merged into a first edit date 346 field in the merged table; and the push time 320 value from the server data is merged into a push date 348 field in the merged table.

With reference again to FIG. 2, the data analyzer 208 is illustrative of a software module, system, or device operative to analyze the merged table 206, and determine various metrics, such as the coding time of a file or a set of files (i.e., the time from when a first edit is made to the file or set of files to when the file or files are committed back to the main codebase). For example, using the information about commits and file edits, the CCTTM tool 110 is enabled to determine a first edit of each push. The report generator 210 is illustrative of a software module, system, or device operative to generate one or more reports 212 of metrics, such as the coding time of a file or a set of files.

Having described an operating environment and components of the CCTTM tool 110 with respect to FIGS. 1-3, FIG. 4 is a flow chart showing general stages involved in an example method 400 for providing centralized tracking and management of coding time in a distributed source control system environment for determining software development agility. The method 400 starts at OPERATION 402, and proceeds to OPERATION 404, where client data 116 is retrieved and stored in a CCTTM tool database. For example, data associated with source code file edits is collected from distributed source control system local repositories 104 on developers' client workstations 108. In some examples, a determination may be made to determine whether a repository exists. If the repository does not exist, the repository is deleted from a list of repositories that is checked for identifying which repositories to query for source code file edits-associated data.

The method 400 proceeds to OPERATION 406, where the list of repositories is checked for identifying which repositories to query, and server data 118 is retrieved from the identified repositories and stored in the CCTTM tool database. For example, data associated with pushes and commits of source code files to the centralized source control server 102 is collected from the centralized source control server.

The method 400 proceeds to OPERATION 408, where the client data 116 and the server data 118 are aggregated, and particular data elements are matched and loaded into a merged table 206.

At OPERATION 410, the data in the merged table 206 is analyzed, and a time from when a developer 106 makes a first edit of each source code file to when the file is committed to the main codebase in the centralized source control server 102 is determined. Other metrics may also be determined via an analysis of the aggregated data, such as an average edit to push time for a particular developer 106, for a particular team, for a particular project, for a particular repository, etc., or an estimated edit to push time for a future project. Further, the analysis may include a comparison of edit to push times for development work performed in different source control systems.

The method 400 proceeds to OPERATION 412, where one or more reports 212 are generated. For example, the reports 212 may include graphs showing results from the analyses performed at OPERATION 410. The method 400 ends at OPERATION 498.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 5-7 and the associated descriptions provide a discussion of a variety of operating environments in which examples are practiced. However, the devices and systems illustrated and discussed with respect to FIGS. 5-7 are for purposes of example and illustration and are not limiting of a vast number of computing device configurations that are utilized for practicing aspects, described herein.

FIG. 5 is a block diagram illustrating physical components (i.e., hardware) of a computing device 500 with which examples of the present disclosure may be practiced. In a basic configuration, the computing device 500 includes at least one processing unit 502 and a system memory 504. According to an aspect, depending on the configuration and type of computing device, the system memory 504 comprises, but is not limited to, volatile storage (e.g., random access memory), non-volatile storage (e.g., read-only memory), flash memory, or any combination of such memories. According to an aspect, the system memory 504 includes an operating system 505 and one or more program modules 506 suitable for running software applications 550. According to an aspect, the system memory 504 includes the commit service 114, edit service 112, and/or the CCTTM tool 110. The operating system 505, for example, is suitable for controlling the operation of the computing device 500. Furthermore, aspects are practiced in conjunction with a graphics library, other operating systems, or any other application program, and is not limited to any particular application or system. This basic configuration is illustrated in FIG. 5 by those components within a dashed line 508. According to an aspect, the computing device 500 has additional features or functionality. For example, according to an aspect, the computing device 500 includes additional data storage devices (removable and/or non-removable) such as, for example, magnetic disks, optical disks, or tape. Such additional storage is illustrated in FIG. 5 by a removable storage device 509 and a non-removable storage device 510.

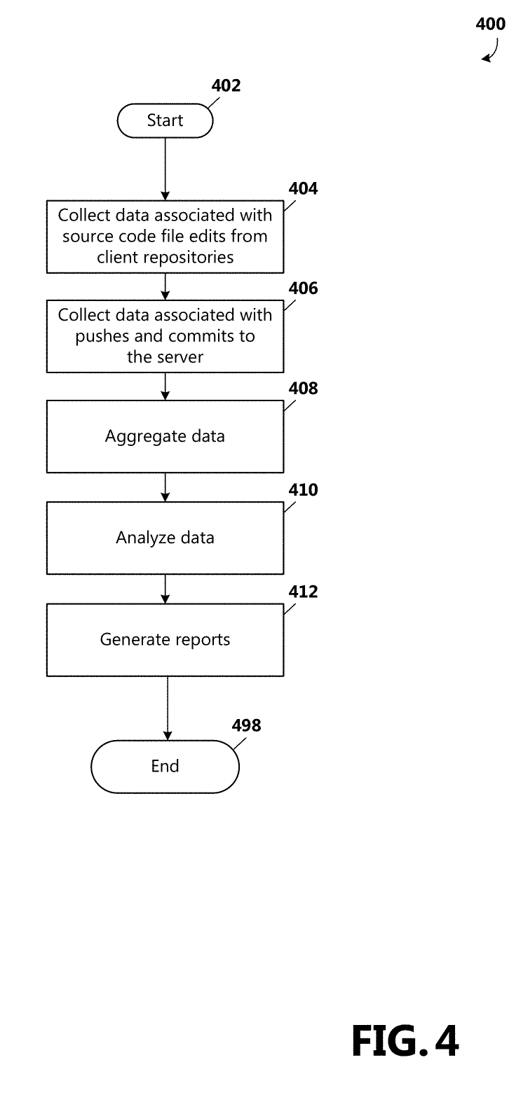

As stated above, according to an aspect, a number of program modules and data files are stored in the system memory 504. While executing on the processing unit 502, the program modules 506 (e.g., commit service 114, edit service 112, and/or the CCTTM tool 110) perform processes including, but not limited to, one or more of the stages of the method 400 illustrated in FIG. 4. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 5 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 500 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 500 has one or more input device(s) 512 such as a keyboard, a mouse, a pen, a sound input device, a touch input device, etc. The output device(s) 514 such as a display, speakers, a printer, etc. are also included according to an aspect. The aforementioned devices are examples and others may be used. According to an aspect, the computing device 500 includes one or more communication connections 516 allowing communications with other computing devices 518. Examples of suitable communication connections 516 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. According to an aspect, any such computer storage media is part of the computing device 500. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

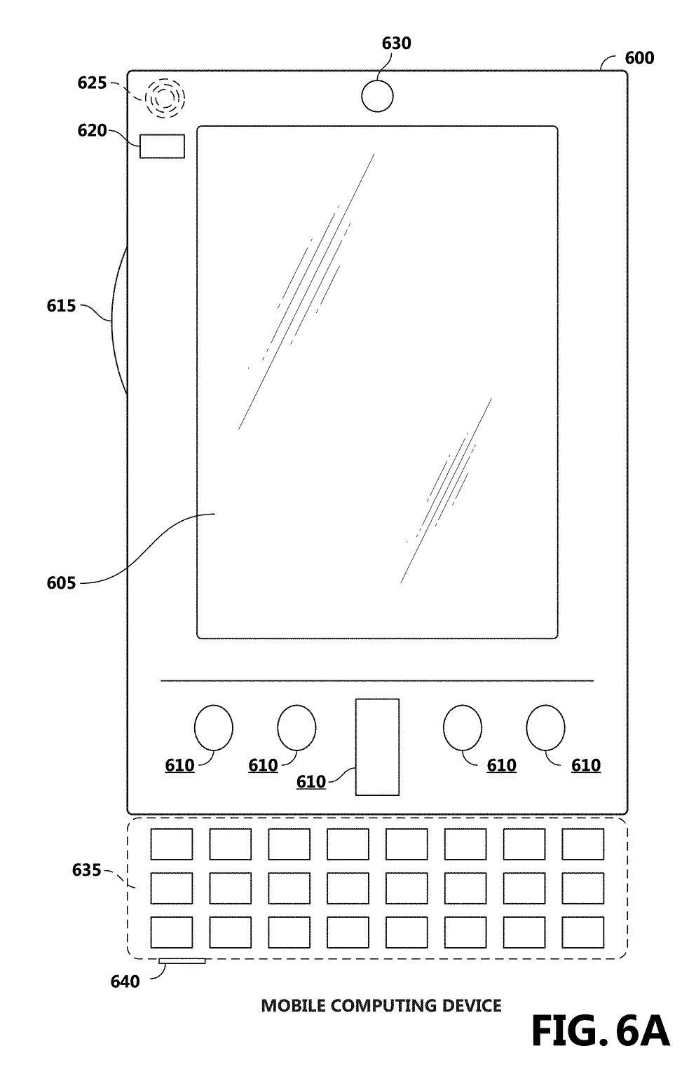

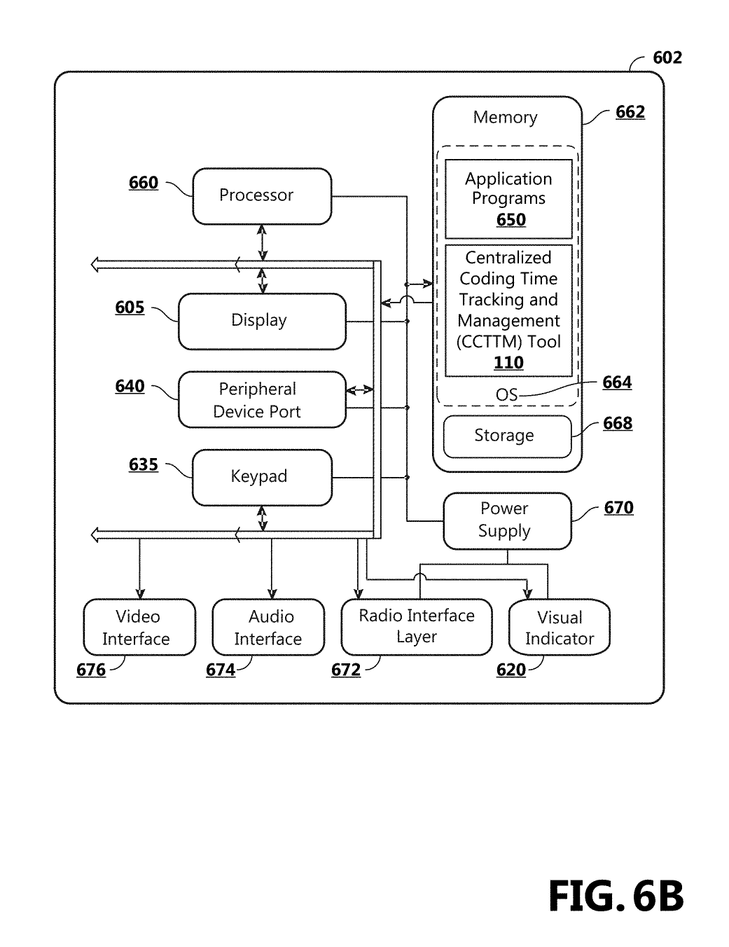

FIGS. 6A and 6B illustrate a mobile computing device 600, for example, a mobile telephone, a smart phone, a tablet personal computer, a laptop computer, and the like, with which aspects may be practiced. With reference to FIG. 6A, an example of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. According to an aspect, the display 605 of the mobile computing device 600 functions as an input device (e.g., a touch screen display). If included, an optional side input element 615 allows further user input. According to an aspect, the side input element 615 is a rotary switch, a button, or any other type of manual input element. In alternative examples, mobile computing device 600 incorporates more or less input elements. For example, the display 605 may not be a touch screen in some examples. In alternative examples, the mobile computing device 600 is a portable phone system, such as a cellular phone. According to an aspect, the mobile computing device 600 includes an optional keypad 635. According to an aspect, the optional keypad 635 is a physical keypad. According to another aspect, the optional keypad 635 is a “soft” keypad generated on the touch screen display. In various aspects, the output elements include the display 605 for showing a graphical user interface (GUI), a visual indicator 620 (e.g., a light emitting diode), and/or an audio transducer 625 (e.g., a speaker). In some examples, the mobile computing device 600 incorporates a vibration transducer for providing the user with tactile feedback. In yet another example, the mobile computing device 600 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 600 incorporates peripheral device port 640, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one example of a mobile computing device. That is, the mobile computing device 600 incorporates a system (i.e., an architecture) 602 to implement some examples. In one example, the system 602 is implemented as a “smart phone” capable of running one or more applications (e.g., browser, e-mail, calendaring, contact managers, messaging clients, games, and media clients/players). In some examples, the system 602 is integrated as a computing device, such as an integrated personal digital assistant (PDA) and wireless phone.

According to an aspect, one or more application programs 650 are loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. According to an aspect, the commit service 114, edit service 112, and/or the CCTTM tool 110 are loaded into memory 662. The system 602 also includes a non-volatile storage area 668 within the memory 662. The non-volatile storage area 668 is used to store persistent information that should not be lost if the system 602 is powered down. The application programs 650 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

According to an aspect, the system 602 has a power supply 670, which is implemented as one or more batteries. According to an aspect, the power supply 670 further includes an external power source, such as an AC adapter or a powered docking cradle that supplements or recharges the batteries.

According to an aspect, the system 602 includes a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 650 via the operating system 664, and vice versa.

According to an aspect, the visual indicator 620 is used to provide visual notifications and/or an audio interface 674 is used for producing audible notifications via the audio transducer 625. In the illustrated example, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. According to an aspect, the system 602 further includes a video interface 676 that enables an operation of an on-board camera 630 to record still images, video stream, and the like.

According to an aspect, a mobile computing device 600 implementing the system 602 has additional features or functionality. For example, the mobile computing device 600 includes additional data storage devices (removable and/or non-removable) such as, magnetic disks, optical disks, or tape. Such additional storage is illustrated in FIG. 6B by the non-volatile storage area 668.

According to an aspect, data/information generated or captured by the mobile computing device 600 and stored via the system 602 is stored locally on the mobile computing device 600, as described above. According to another aspect, the data is stored on any number of storage media that is accessible by the device via the radio 672 or via a wired connection between the mobile computing device 600 and a separate computing device associated with the mobile computing device 600, for example, a server computer in a distributed computing network, such as the Internet. As should be appreciated such data/information is accessible via the mobile computing device 600 via the radio 672 or via a distributed computing network. Similarly, according to an aspect, such data/information is readily transferred between computing devices for storage and use according to well-known data/information transfer and storage means, including electronic mail and collaborative data/information sharing systems.

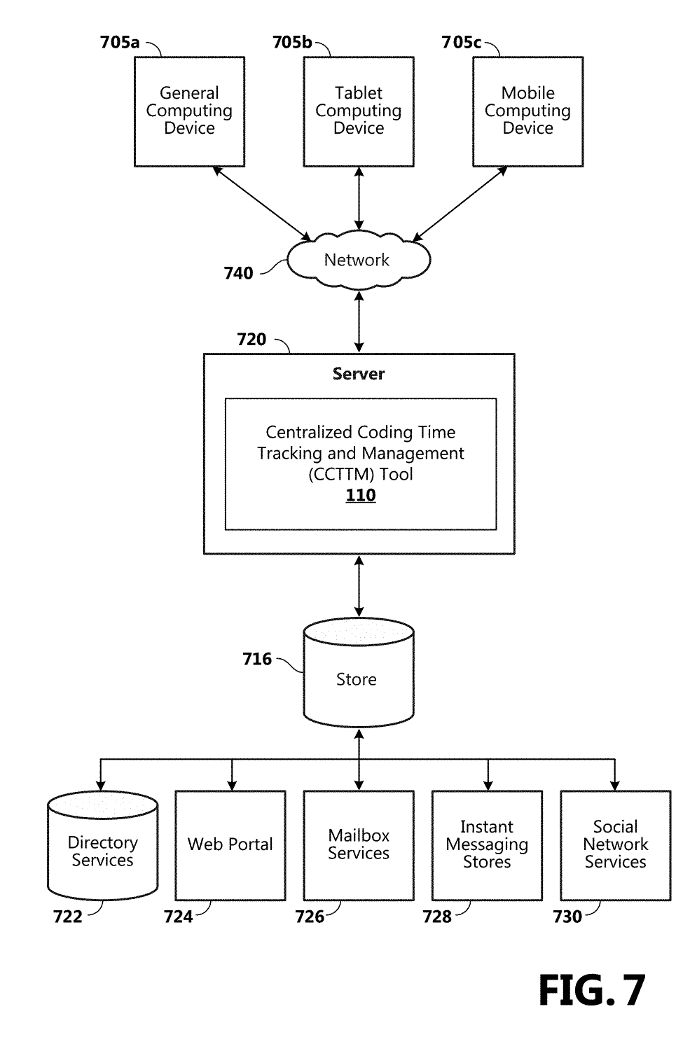

FIG. 7 illustrates one example of the architecture of a system for providing centralized tracking and management of coding time in a distributed source control system environment for determining software development agility as described above. Content developed, interacted with, or edited in association with the commit service 114, edit service 112, and/or the CCTTM tool 110 is enabled to be stored in different communication channels or other storage types. For example, various documents may be stored using a directory service 722, a web portal 724, a mailbox service 726, an instant messaging store 728, or a social networking site 730. The commit service 114, edit service 112, and/or the CCTTM tool 110 are operative to use any of these types of systems or the like for providing centralized tracking and management of coding time in a distributed source control system environment for determining software development agility, as described herein. According to an aspect, a server 720 provides the commit service 114, edit service 112, and/or the CCTTM tool 110 to clients 705a,b,c. As one example, the server 720 is a web server providing the commit service 114, edit service 112, and/or the CCTTM tool 110 over the web. The server 720 provides the commit service 114, edit service 112, and/or the CCTTM tool 110 over the web to clients 705 through a network 740. By way of example, the client computing device is implemented and embodied in a personal computer 705a, a tablet computing device 705b or a mobile computing device 705c (e.g., a smart phone), or other computing device. Any of these examples of the client computing device are operable to obtain content from the store 716.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A computer-implemented method for managing and tracking coding time of a source code file in a distributed source control environment, the method comprising:
retrieving source code file edit time data from a plurality of data sources at selected intervals;
storing the retrieved data in a database;
retrieving file commit data related to related pushes of source code file edits to a centralized repository at selected intervals;
for each source code file edit, aggregating the file edit time data and the file commit data into a merged table; and
determining the coding time for the source code file edit.

2. The method of claim 1, wherein retrieving source code file edit time data further comprises:
retrieving a list of source code files that are currently being edited; and
updating a list of repositories to query for pushes of source code file edits.

3. The method of claim 2, wherein prior to retrieving file commit data related to related pushes of source code file edits, accessing the list of repositories for determining which repositories to query.

4. The method of claim 1, wherein aggregating the file edit time data and the file commit data into a merged table comprises matching values of pieces of the file edit time data and pieces of the file commit data.

5. The method of claim 4, wherein matching values of pieces of the file edit time data and the file commit data comprises matching:
an organization value from the file edit time data to an organization value from the file commit data;
a team value from the file edit time data and a team value from the file commit data;
a repository value from the file edit time data and a repository value from the file commit data;
a user alias value from the file edit time data and a committer alias value from the file commit data; and
a file path value from the file edit time data and a file path value from the file commit data.

6. The method of claim 1, wherein aggregating the file edit time data and the file commit data into the merged table comprises:
adding an edit time value from the file edit time data to a first edit date field in the merged table; and
adding a push time value from the file edit time data to a push date field in the merged table.

7. The method of claim 1, wherein retrieving source code file edit time data from the plurality of data sources at selected intervals comprises retrieving source code file edit time data from a plurality of local distributed source control system repositories.

8. The method of claim 1, further comprising generating a report related to the determined coding time.

9. A system for managing and tracking coding time of a source code file in a distributed source control environment, the system comprising a computing device, the computing device comprising:
at least one processing device; and
at least one computer readable data storage device storing instructions that, when executed by the at least one processing device, provides a centralized coding time tracking and management tool operative to:
retrieve source code file edit time data from a plurality of data sources at selected intervals;
store the retrieved data in a database;
retrieve file commit data related to related pushes of source code file edits to a centralized repository at selected intervals;
for each source code file edit, aggregate the file edit time data and the file commit data into a merged table; and
determine the coding time for the source code file edit.

10. The system of claim 9, wherein in aggregating the file edit time data and the file commit data into a merged table, the centralized coding time tracking and management tool is operative to match values of pieces of the file edit time data and pieces of the file commit data.

11. The system of claim 10, wherein in matching values of pieces of the file edit time data and the file commit data, the centralized coding time tracking and management tool is operative to match:
an organization value from the file edit time data to an organization value from the file commit data;
a team value from the file edit time data and a team value from the file commit data;
a repository value from the file edit time data and a repository value from the file commit data;
a user alias value from the file edit time data and a committer alias value from the file commit data; and
a file path value from the file edit time data and a file path value from the file commit data.

12. The system of claim 9, wherein in aggregating the file edit time data and the file commit data into the merged table, the centralized coding time tracking and management tool is operative to:
add an edit time value from the file edit time data to a first edit date field in the merged table; and
add a push time value from the file edit time data to a push date field in the merged table.

13. The system of claim 9, wherein the plurality of data sources include a plurality of local distributed source control system repositories.

14. The system of claim 9, wherein the centralized coding time tracking and management tool is further operative to generate a report related to the determined coding time.

15. The system of claim 9, wherein the centralized coding time tracking and management tool is further operative to
retrieve a list of source code files that are currently being edited; and
update a list of repositories to query for pushes of source code file edits.

16. The system of claim 15, wherein prior to retrieving file commit data related to related pushes of source code file edits, the centralized coding time tracking and management tool is operative to access the list of repositories for determining which repositories to query.

17. A computer readable storage device including computer readable instructions, which when executed by a processing unit is operative to:
retrieve source code file edit time data from a plurality of data sources at selected intervals;
store the retrieved data in a database;
retrieve file commit data related to related pushes of source code file edits to a centralized repository at selected intervals;
for each source code file edit, aggregate the file edit time data and the file commit data into a merged table;
determine the coding time for the source code file edit; and
generate a report related to the determined coding time.

18. The computer readable storage device of claim 17, wherein in aggregating the file edit time data and the file commit data into a merged table, the computer readable instructions are operative to match values of pieces of the file edit time data and pieces of the file commit data.

19. The computer readable storage device of claim 17, wherein the computer readable instructions are further operative to:
retrieve a list of source code files that are currently being edited;
update a list of repositories to query for pushes of source code file edits; and
wherein prior to retrieving file commit data related to related pushes of source code file edits, computer readable instructions are further operative to access the list of repositories for determining which repositories to query.

20. The computer readable storage device of claim 17, wherein in aggregating the file edit time data and the file commit data into the merged table, the computer readable instructions are operative to:
add an edit time value from the file edit time data to a first edit date field in the merged table; and
add a push time value from the file edit time data to a push date field in the merged table.
